(19) United States
(12) Patent Application Publication
(10) Pub. No.: US 2024/0342649 A1
(43) Pub. Date: Oct. 17, 2024

(54) SEAWATER ELECTROLYSIS ENABLES SCALABLE ATMOSPHERIC CO2 MINERALIZATION

(71) Applicant: The Regents of the University of California, Oakland, CA (US)

(72) Inventors: Erika Callagon La Plante, Los Angeles, CA (US); Gaurav Sant, Los Angeles, CA (US); Xin Chen, Los Angeles, CA (US); David Jassby, Los Angeles, CA (US); Dante Simonetti, Los Angeles, CA (US); Yenwen Tseng, Los Angeles, CA (US); Thomas Traynor, Los Angeles, CA (US)

(21) Appl. No.: 18/574,587

(22) PCT Filed: Jun. 28, 2022
(86) PCT No.: PCT/US22/35289

§ 371 Date: Dec. 27, 2023

Related U.S. Application Data
(60) Provisional application No. 63/215,853, filed on Jun. 28, 2021.

(51) Int. Cl. B01D 53/62; B01D 53/14; B01D 53/96; C25B 1/18; C25B 11/03; C25B 11/052; C25B 11/063; C25B 11/081

(52) U.S. Cl. CPC B01D 53/62; B01D 53/1425; B01D 53/1475; B01D 53/965; C25B 1/18; C25B 11/03; C25B 11/052; C25B 11/063; C25B 11/081; B01D 2251/304; B01D 2251/402; B01D 2251/404; B01D 2252/1035; B01D 2252/20421; B01D 2257/504

(57) ABSTRACT

Disclosed herein are methods of capturing CO2 from a gas source using electrochemically-enhanced amine capture to form a concentrated CO₂ vapor, followed by sequestering CO₂ from the concentrated vapor in a sequestration step. The sequestration step includes contacting the concentrated vapor with an aqueous sequestration solution comprising ions capable of forming an insoluble carbonate salt, such that the aqueous sequestration solution comprises the CO₂, electrochemically basifying the sequestration solution, thereby precipitating a carbonate solid, separating the carbonate solids from the aqueous sequestration solution or the surface of the mesh.

### CROSS-REFERENCE TO RELATED APPLICATIONS

This application claims the benefit of priority to U.S. Provisional Patent Application No. 63/215,853, filed Jun. 28, 2021, the contents of which are incorporated herein by reference in their entirety.

### STATEMENT OF GOVERNMENT SUPPORT

This invention was made with Government support under Contract No. DE-FE0031705 awarded by the United States Department of Energy. The Government has certain rights in the invention.

### BACKGROUND

Transformative technologies that can capture gigatons (Gt) of CO₂ are vital to mitigate climate change. Various CO₂ capture, sequestration, and storage processes (CCSS) have been investigated to manage CO₂ emissions from various sources. Current technologies for carbon capture using amines rely on a thermal swing cycle in which CO₂ is absorbed in a bubble-flow column, after which regeneration of the CO₂-rich amine solution occurs in a packed distillation column at >140° C. While this process has been used for post-combustion capture in power generation it suffers from large energy intensities needed to desorb only a fraction (˜50%) of the CO₂ trapped in the amine solution at large energy intensities (1.2 MWh per tonne of CO₂ for power generation and 5.0 MWh per tonne of CO₂ for DAC). The low amine regeneration extent leads to low working CO₂ absorption capacities (e.g., ˜0.05 and 0.25 mol CO₂ per mol MEA for DAC and power generation, respectively. (See E. S. Sanz-Perez, et al., Direct Capture of CO₂ from Ambient Air, 116 CHEM. REV. 11840-76 (2016).) Further, the high temperatures required for amine regeneration (>140° C.) result in solvent loss via chemical degradation and evaporation.

Use of caustic solutions (e.g., KOH/K₂CO₃) for direct air capture also suffers from high energy intensities required to produce mineral reagents for pH swing processes (e.g., 4.5 MWh per tonne CO₂ for chlor-alkali to produce NaOH and HCl). Adsorption using solid materials has also been proposed for direct air capture, however, these processes also suffer from high energy requirements for desorption (>2.0 MWh per tonne CO₂).

Strategies for indirect capture via seawater have also been proposed, however, these strategies require either complex electrochemical cells (e.g., electrodialysis) and/or mineralization strategies that rely on slow precipitation kinetics. For instance, precipitation of Mg-carbonate species from seawater requires elevated carbonate concentrations (>100 mM) over prolonged time scales (weeks to months). (See I. M. Power, et al., Room Temperature Magnesite Precipitation, 17 CRYST. GROWTH DES. 5652-59 (2017).)

Therefore, there exists great interest in more efficient and less energy-intensive processes for direct air capture of CO₂.

### SUMMARY OF THE INVENTION

In some embodiments, the present disclosure relates to a method of capturing CO₂ from a gas source, comprising: (a) concentrating CO₂ from the gas source in a concentration step comprising: (i) contacting the gas source with an absorption solution having a solvent and a solute, wherein the solvent and/or the solute comprises an amine, thereby forming a solution comprising the amine-CO₂ complex; (ii) electrochemically adjusting the pH of the absorption solution electrochemically to less than about 7 to, thereby releasing the CO₂ as a concentrated vapor; (iii) collecting the concentrated vapor; and (b) sequestering CO₂ from the concentrated vapor in a sequestration step comprising: (iv) contacting the concentrated vapor with an aqueous sequestration solution comprising ions capable of forming an insoluble carbonate salt, such that the aqueous sequestration solution comprises the CO₂; (v) contacting the aqueous sequestration solution comprising the CO₂ with an electroactive surface to basify the aqueous sequestration solution comprising the CO₂, thereby precipitating a carbonate solid; and (vi) separating the carbonate solids from the aqueous sequestration solution or the electroactive surface.

In some embodiments, anionic complex comprises carbamate ions.

In some embodiments, the solvent comprises an amine, while in others the solute comprises an amine, while in still others, the solvent and the solute comprise an amine. The amine may be a primary amine, a secondary amine, a tertiary amine, or a mixture thereof. Preferably, the amine is a primary or secondary amine.

In some embodiments, the amine has a structure of formula I:

RₓNH₃₋ₓ, (I);
wherein R is selected from an optionally substituted alkyl, ether, and hydroxyalkyl, or two R, together with the nitrogen atom to which they are joined, forms a nitrogen containing heterocycle; and
x is 1, 2 or 3.

In some embodiments, the amine is chosen from monoethanolamine, 2-ethylaminoethanol, 2-methylaminoethanol, ethylenediamine, benzylamine, diethanolamine, pyrrolidine, morpholine, 2,6-dimethylmorpholine, monoisopropanolamine, piperazine 2-(dimethylamino) ethanol, N-tert-butyldiethanolamine, 3-dimethylamino-1-propanol, 3-(dimethylamino)-1,2-propanediol, 2-diethylaminoethanol, 3-diethylamino-1,2-propanediol, 3-diethylamino-1-propanol, triethanolamine, 1-dimethylamino-2-propanol, 1-(2-hydroxyethyl) pyrrolidine, 1-diethylamino-2-propanol, 3-pyrrolidino-1,2-propanediol, 2-(diisopropylamino) ethanol, 1-(2-hydroxyethyl) piperidine, 2-(dimethylamino)-2-methyl-1-propanol, 3-piperidino-1,2-propanediol, 3-dimethylamino-2,2-dimethyl-1-propanol, 3-hydroxy-1-methylpiperidine, N-ethyldiethanolamine, 1-ethyl-3-hydroxypiperidine, and any combination thereof.

In some embodiments, the solvent comprises water.

In some embodiments, the gas source comprise about 0.4 to about 25% (v/v) CO₂. The gas source may be gas source is an effluent from an industrial source, atmospheric air, or a combination thereof.

In some embodiments, the pH adjusting step is performed via water electrolysis. In some embodiments, the gas source is an effluent from an industrial source or ambient air. In some embodiments, the pH adjusting step is performed at a temperature of less than 100° C. In some embodiments, the regenerated solvent is collected and used for the same process again. In some embodiments, the gas source is an atmospheric source (e.g., ambient air).

In some embodiments, the concentrated vapor comprises about 2-99% (v/v) CO₂. In some embodiments, the concentrated vapor comprises 2-15% (v/v) CO₂.

In some embodiments, the absorption solution is regenerated using a strong base anion exchange resin.

In some embodiments, the aqueous sequestration solution is in thermal equilibrium with the gaseous stream. In some embodiments, the aqueous sequestration solution is not in thermal equilibrium with the gaseous stream.

In some embodiments, the ions capable of forming an insoluble carbonate salt comprise ions including one or more of the following Ca, Mg, Ba, Sr, Fe, Zn, Pb, Cd, Mn, Ni, Co, Cu, and Al. In some embodiments, the aqueous sequestration solution has a concentration of NaCl of about 1,000 ppm or more. In some embodiments, the aqueous sequestration solution has a concentration of NaCl of about 30,000 ppm or more. In some embodiments, the aqueous sequestration solution comprises seawater. In some embodiments, the aqueous sequestration solution is a brine solution. In some embodiments, the aqueous sequestration solution is an alkaline metal-containing solution.

In some embodiments, the electroactive surface comprises a cathode that comprises a metallic or a non-metallic composition. In some embodiments, the electroactive surface is a mesh that produces an increased alkaline condition, in situ, in the aqueous sequestration solution within about 2 to 20000 μm of the electroactive mesh. In some embodiments, the alkalinized condition is a pH of 9 or greater. In some embodiments, the electroactive mesh consists of a metallic or carbon-based mesh. In some embodiments, the electroactive mesh comprises a metal (such as steel, stainless steel, titanium oxide, nickel and nickel alloys), carbon nanotubes, polymers, and/or graphite, or other hybrid compositions of these materials. In some embodiments, the electroactive mesh comprises pores having a diameter in the range of about 0.1 μm to about 10000 μm.

In some embodiments, inducing precipitation of the carbonate solid includes inducing precipitation of at least one carbonate having Ca, Mg, Ba, Sr, Fe, Zn, Pb, Cd, Mn, Ni, Co, Cu, or Al.

In some embodiments, removing the precipitated carbonate solids from the sequestration solution, or the surface of the mesh, comprises rotating a rotating disc cathode having the mesh on its surface past a scraper, wherein the scraper removes the precipitated carbonate from the surface of the mesh.

### BRIEF DESCRIPTION OF THE DRAWINGS

FIG. 1A is a schematic illustration of a process of CO₂ capture and mineralization according to the present disclosure.

FIG. 1B is a schematic illustration of a CO₂ absorption process according to the present disclosure.

FIG. 2 is a schematic of an exemplary electrochemical cell 200 useful in amine-based CO₂ capture comprising a cathode 201, an anode 202, a second cation exchange membrane 203, an anion exchange membrane 204, a first cation exchange membrane 205, a base solution 206, a salt solution 207, an amine solution 208, and an acid solution 209.

FIG. 3 is a plot of pH values (circles) and extents of CO₂ desorption (triangles) at various solution proton: MEA ratios for 22 vol % MEA solutions with CO₂ loadings of 0.25 (red) and 0.5 (black) mol CO₂ per mol MEA.

FIG. 4A is a cross-sectional illustration of an exemplary scalable carbon dioxide mineralization reactor, wherein an online pH-monitoring system controls the applied electric current to attain a constant catholyte pH that enables atmospheric CO₂ capture and mineralization. The reactor employs rotating disc cathodes (316L stainless steel mesh) which are rotated to pass a scraper for products removal and collection.

FIG. 4B is a cross-sectional illustration of a lab-scale, single-compartment CSTR.

FIGS. 5A and 5B show pH evolution in a carbon dioxide mineralization process (150 min. HRT and 10-min. HRT, respectively) demonstrated using air, seawater, and the reactor design shown in FIG. 4B.

FIGS. 5C and 5D show Ca²⁺ removal in a carbon dioxide mineralization process (150 min. HRT and 10-min. HRT, respectively) demonstrated using air, seawater, and the reactor design shown in FIG. 4B.

FIGS. 5E and 5F show acquired effluent inorganic carbon (IC) in a carbon dioxide mineralization process (150 min. HRT and 10-min. HRT, respectively) demonstrated using air, seawater, and the reactor design shown in FIG. 4B. The insets in FIGS. 5E and 5F are scanning electron images showing thick layers of aragonite (CaCO₃) formed on the PP meshes.

### DETAILED DESCRIPTION

The process according to the present disclosure is based on a series of electrochemically enhanced reactors that exploit water electrolysis to generate the necessary protons and/or hydroxide ions for energy efficient CO₂ concentration and storage. The first step in the overall process involves separation of CO₂ from air (e.g., absorption of CO₂) using an absorption solution (e.g., an aqueous amine solution). Such processes include, but are not limited to, those disclosed in PCT Application No. PCT/US22/25028, filed Apr. 15, 2022, the entirety of which is hereby incorporated by reference herein. The second step in the process includes releasing the absorbed carbon species in a concentrated CO₂ gas stream. The third step in the process includes sequestering the separated CO₂ from the amine-based CO₂ absorption process by mineralization in an aqueous solution (e.g., seawater or brine). Such processes include, but are not limited to, those disclosed in PCT Publication No. WO 2021/061213, filed Jun. 12, 2020, the entireties of which are hereby incorporated by reference herein.

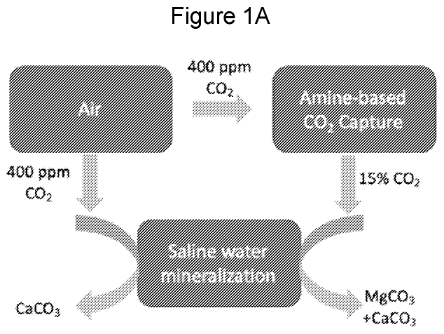

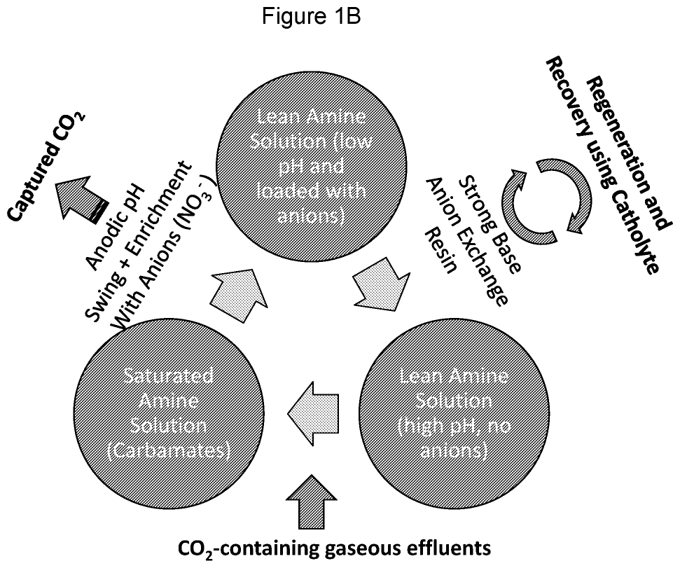

FIG. 1B illustrates the overall CO₂ capture process according to the present disclosure. Briefly, CO₂ is absorbed from one or more gaseous sources (e.g., air or industrial process gas) into aqueous amine solutions by formation of anionic complexes (e.g., carbamate complexes). CO₂ is then desorbed from the amine via electrochemically induced acidification. The amine solution is regenerated for further absorption using a strong base anion exchange resin that is regenerated using alkaline catholyte from the electrochemical step.

This process uses amine solutions (at pH>10) to absorb CO₂ from gas sources. However, the CO₂-rich amine would be regenerated in an electrochemical cell in which protons are generated from aqueous solutions at the anode (and hydroxide ions at the cathode). These protons diffuse into the rich amine solution, resulting in a decrease in the pH of the amine solution (pH<7) and the decomposition of carbamate ions and release of CO₂ (e.g., as a concentrated vapor comprising CO₂). The CO₂ may be released as a gaseous stream containing 1-99% CO₂. A salt bridge supplies anions to maintain charge neutrality in the amine solution and cations to the cathode solution.

Referring still to FIG. 1B, after CO₂ is released, the amine solution is restored to high pH via ion exchange using a strong base anion exchange resin. The basic solution from the cathode is used to regenerate the ion exchange resin, thereby recovering the salts for recycle into the salt bridge solution.

This electrochemically-induced pH-swing process has the advantages of replacing hazardous, expensive, and carbon-intensive reagents (e.g., mineral acids) with an abundant and benign source (e.g., water) while also leveraging renewable energy to facilitate the process. Thus, the technology disclosed herein seeks to integrate water electrolysis into an amine absorption process to induce pH-swings via electrochemically generated protons and hydroxide ions thereby achieving higher working capacities in an energy efficient and low carbon intensity manner. This pH-swing process occurs at ambient temperature, and therefore offers the following advantages: (1) simpler process equipment requirements; (2) complete amine regeneration (and thus, maximum working capacity); and (3) reduced solvent loss. Particular aspects of the electrochemically-induced pH-swing process, as disclosed in PCT Application No. PCT/US22/25028, filed Apr. 15, 2022, are discussed below.

CO₂ Absorption by Electrochemically-Induced pH-Swing Process

During a conventional amine scrubbing process, CO₂-containing gases, are contacted with a concentrated (20-50% v/v) aqueous amine solution. Under basic conditions (pH>10), absorption occurs via the reaction of CO₂ with the amine (e.g., MEA; RNH₂ where R═CH₂CH₂OH) to form carbamate anions (RNHCOO⁻, RNCOO²⁻), protonated amines (RNH₃⁺), and protons/hydronium ions (H⁺/H₃O⁺), according to Equations 1-3, while other gases, such as N₂ and O₂, escape in the effluent. CO₂ also forms carbonates at high pH (Equation 4).⁴

$$R N {H}_{2} + C {O}_{2} ⇔ {H}^{+} + R N H C O {O}^{-} \qquad ( 1 )$$

$$R N H C O {O}^{-} + R N {H}_{2} ⇔ R N {H}_{3}^{+} + R N C O {O}^{2 -} \qquad ( 2 )$$

$$R N H C O {O}^{-} + {H}_{2} O ⇔ {H}_{3} {O}^{+} + R N C O {O}^{2 -} \qquad ( 3 )$$

$$C {O}_{2} + {H}_{2} O ⇔ C {O}_{3}^{2 -} + 2 {H}^{+} \qquad ( 4 )$$

The existing approach to releasing the CO₂ and regenerating the amine is a thermal process. In the thermal process, the solution is heated to elevated temperatures (>140° C.) where the carbamate decomposes to yield the original amine molecule and release CO₂ as a concentrated vapor.^{3, 5-6} However, large thermal duties (e.g., >5 MWh/tonne of CO₂ for a working capacity of 0.05 mol/mol for DAC applications)³ render the thermal process economically unattractive. Further, the high temperatures required for amine regeneration can result in solvent loss via chemical degradation and evaporation.³ These factors can result in up to a 50% increase in CAPEX and up to 25% increase in OPEX, which lead to high costs of carbon capture (>$100 per tonne CO₂)⁷⁻⁸ and restrict the use of amine-based processes to point source emitters (e.g., fossil-fuel fired power plants).

An alternative to thermal amine regeneration is to shift the pH of the solution to acidic conditions (pH≤7), which favors the decomposition of the carbamate ions (via acid-hydrolysis) according to the reverse of Equations (1) and (3). This pH-swing process can occur at ambient temperatures, and therefore offers the following advantages: (1) simpler process equipment requirements; (2) utilization of the maximum working capacity of the amine; and (3) reduced solvent loss. However, the requirement for acids and bases as stoichiometric reagents to shift the pH renders pH-swing processes unfeasible for widespread adoption. An alternative to mineral acids and bases is to use water electrolysis to generate the necessary protons for carbamate ion hydrolysis (e.g., to convert a rich amine solution to a lean solution) and to generate hydroxide ions needed to increase the pH of the lean solution for subsequent cycles of CO₂ absorption (FIG. 1B (left side)).

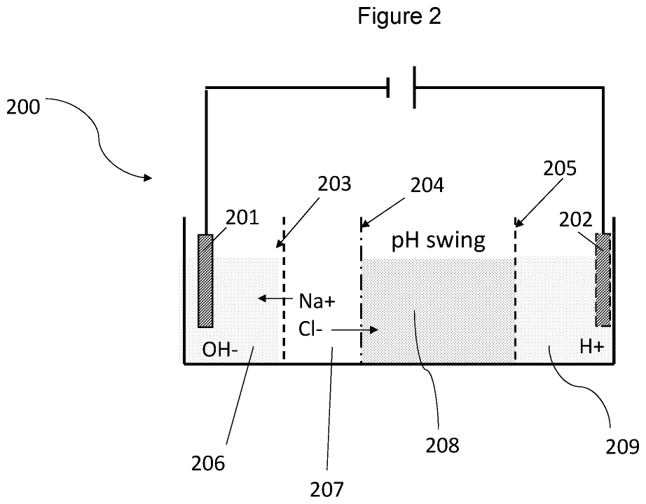

Referring now to FIG. 2, in this approach, protons are generated from aqueous solutions at the anode (with hydroxide ions generated at the cathode) in an electrochemical cell according to Equations (5) and (6) below:

$$2 {H}_{2} O ( l ) \to {O}_{2} ( g ) + 4 {H}^{+} ( aq ) + 4 {e}^{-} ; {E}_{0} = 1.23 V vs . SHE \qquad ( 5 )$$

$$4 {H}_{2} O ( l ) + 4 {e}^{-} \to 2 {H}_{2} ( g ) + 4 {OH}^{-} ( aq ) ; {E}_{0} = - 0 \text{.83} V vs . SHE \qquad ( 6 )$$

The protons diffuse into the rich amine solution across a cation exchange membrane (CEM) resulting in a decrease in the pH which leads to the decomposition of carbamate ions and release of CO₂. A CEM is included to prevent diffusion of carbamate anions into the anode and cathode chambers, thereby preventing electro-oxidation of carbamates/MEA. To maintain electroneutrality, a concentrated salt solution (e.g., NaCl or NaNO₃) is used to provide counter anions to the amine solution and cations to the catholyte. An anion exchange membrane (AEM) prevents the diffusion of the salt solution cations into the MEA compartment. After CO₂ is released, the lean amine solution is restored to high pH using a strong base anion exchange resin (FIG. 1B (right side)). This resin exchanges the counter ions (e.g., Cl⁻ or NO₃⁻) from the salt reservoir (e.g., that have accumulated in the amine solution) with hydroxide ions to increase the pH of the lean amine to its original basic value.

The anion exchange resin is regenerated using the hydroxide rich solution from the cathode compartment of the electrochemical cell, thereby recovering the anions used in the salt solution compartment. This regeneration process ensures efficient recycling of the necessary reagents, minimizing operating costs and preventing waste generation. This electrochemically-induced pH-swing process has the advantages of replacing hazardous, expensive, carbon-intensive reagents (e.g., mineral acids) with an abundant and benign source (e.g., water) while leveraging renewable energy to facilitate the process.

### Incorporation of Electrochemical Reactions for Amine Regeneration

Some recent studies focused on exploiting electrochemistry for amine-based CO₂ capture.⁹⁻¹⁶ These studies use a complexation reaction between a metal (e.g., Cu²⁺ ions) and the amine, which decomposes the carbamate ion and releases CO₂.^{11-12, 14-16} This complexation reaction is electrochemically driven at the anode (where Cu²⁺ ions are generated from oxidation of Cu metal), with the Cu-amine complex being regenerated back to amines (with Cu²⁺ being reduced to Cu metal) at the cathode.

This work was extended to electrochemical CO₂ capture on solid polyanthraquionones.^{9,13} In this system, a Faradaic electro-swing process is used to capture CO₂ via carboxylation reactions (reduction) with quinones (with polyvinylferrocene being oxidized) followed by reversing the polarity of the cell to decompose the carboxyl-quinone compound (and reduce the polyvinylferrocene), thereby desorbing CO₂ and regenerating the polyanthraquionone. While these electrochemical processes have exhibited high working capacities (as much as 0.62 mol CO₂ per mol amine for 12% v/v CO₂ streams) and low energy requirements (theoretical minimum requirements of ˜0.60 MWh per tonne CO₂), they also require complicated Cu-based redox chemistry with expensive diamines or quinones. Further, the electrochemistry operates directly on the amine. These features could facilitate amine or electrode degradation, leading to more expensive CAPEX/OPEX.¹⁷ Importantly, these studies also focused on the much higher CO₂ concentrations in power plant applications (˜12%) and not those in direct air (DAC) applications (˜400 ppm).

Integrating water electrolysis into amine regeneration has two primary advantages. First, performing water electrolysis in isolated anode/cathode chambers allows for localized generation of protons and hydroxides without the need for stoichiometric or expensive/exotic regents, catalysts, or materials and with reduced risk of electrochemical degradation of the amines/electrodes. Second, water electrolysis at the cathode generates H₂, thereby providing an opportunity for realistic energy requirements of 2.0 MWh/tonne CO₂ by capturing and using the evolved H₂. An additional benefit of using electrochemical processes is that up to 100% of the required energy can be supplied from renewable sources. These innovations impact both the process equipment and energy efficiencies. Complete regeneration of the amine molecules at ambient temperature can be achieved via acid-mediated carbamate decomposition. This impacts process equipment by (1) reducing the amount of amine required by an amount that is proportional to the capacity increase and (2) replacing complex distillation towers with simpler, modular electrochemical cells and anion exchange columns. This simpler process equipment has the potential for reducing CAPEX (e.g., less than the >$60 million investment cost for an amine stripper column⁷) and increasing the flexibility and modularity of the system, both of which would allow for the use of the process in a wider array of applications (e.g., capture from industrial processes and directly from air).

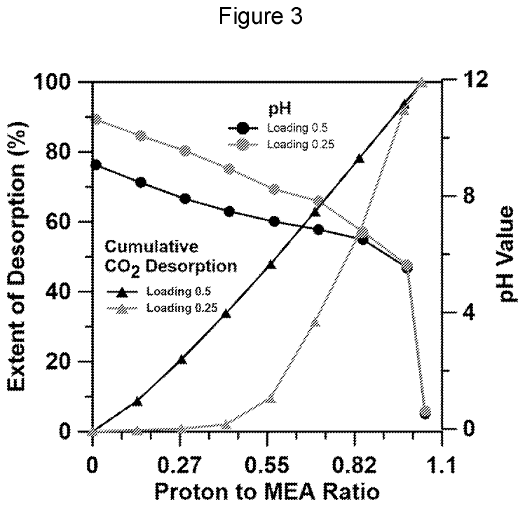

Realistic energy requirements for the electrochemically enhanced amine process can be estimated based on the number of protons required to desorb CO₂ and on current state-of-the-art electrolyzers operating at ˜80% efficiency (e.g., 68 kWh per kg H₂ produced¹⁸ assuming a thermodynamic demand of 54.8 kWh/kg for the stoichiometric hydrogen evolution reaction as shown in equations (5) and (6)¹⁹). For example, titration of a 22% MEA solution at various CO₂ loadings (see FIG. 3; 0.25 and 0.5 mol CO₂ per mol MEA) shows that ˜1.0 mol of H⁺ per mol of MEA is required for a pH decrease from 12 to 0.6 (the point at which all CO₂ is desorbed). From this information, energy requirements can be estimated for two embodiments of the technology: (1) DAC with an initial MEA loading is 0.25 mol CO₂ per mol MEA²⁰ and (2) industrial effluents containing between 1-12% CO₂ (initial loading of 0.5 mol CO₂ per mol MEA).

In some embodiments for direct air capture (“DAC”) applications, the ratio of protons to CO₂ is ˜4 for complete desorption. Using current electrolyzers, the process would require 6.3 MWh/tonne CO₂ removed. If ˜70% of the H₂ energy is recovered, this value decreases to 3.8 MWh/tonne CO₂ removed. At 95% cell efficiency, the energy requirements may be 5.3 and 2.8 MWh/tonne CO₂ without and with H₂ recovery, respectively. By comparison for a traditional thermal swing process, the reboiler duty required to desorb CO₂ from a loading of 0.30 to 0.25 mol CO₂ per mol MEA is ˜5.0 MWh/tonne CO₂,³ and the duty required for complete desorption would be >25 MWh/tonne CO₂.^{3, 21} This preliminary energy analysis indicates that the process could not only currently be carried out at much lower energy requirements than traditional thermal swing processes (6.3 versus 25.0 MWh/tonne CO₂), but could also potentially achieve a factor of 5× higher working capacity (0.25 versus 0.05 mol CO₂/mol MEA).

For applications with effluents containing >1% CO₂, the energy requirements decrease. For example, assuming that the initial MEA loading is 0.5 mol CO₂ per mol MEA, the ratio of protons to CO₂ is ˜2 for complete desorption. At an 80% efficiency, the process would require 3.1 MWh/tonne CO₂ removed. If ˜70% of the H₂ energy is recovered, this value decreases to 1.9 MWh/tonne CO₂ removed. At 95% cell efficiency, the energy requirements are 2.6 and 1.4 MWh/tonne CO₂ without and with H₂ recovery, respectively. By comparison for a traditional thermal swing process, the reboiler duty required to desorb CO₂ from a loading of 0.5 to 0.25 mol CO₂ per mol MEA is ˜1.3 MWh/tonne CO₂.⁵ This duty increases to >2.2 MWh/tonne CO₂ for desorption to less than 0.20 mol CO₂ per mol MEA and is >5 MWh/tonne CO₂ for desorption from less concentrated amines (e.g., from 0.3 to 0.2 mol CO₂ per mol MEA).⁵ Based on these studies, the duty required for complete desorption would be >25 MWh/tonne CO₂ because CO₂ desorption is thermodynamically un-favored at low CO₂ loadings.^{5, 32} This preliminary energy analysis indicates that the process could currently be carried out at comparable energy requirements as traditional thermal swing processes (1.9 versus 1.3 MWh/tonne CO₂) and could potentially achieve a factor of 2× higher working capacity (0.5 versus 0.25 mol CO₂ per mol MEA).

In some embodiments, the methods of the present disclosure include a method or step of absorbing CO₂, comprising: contacting a gas source comprising CO₂ with an absorption solution comprising a solvent capable of forming an anionic complex; adjusting the pH of the absorption solution electrochemically to less than about 7; collecting the CO₂ as a concentrated vapor that is released during or after the pH adjusting step; regenerating the solvent and/or solute; and optionally collecting the regenerated solvent and/or solute. In some embodiments, the anionic complex comprises carbamate ions and/or a hydroxide (e.g., sodium hydroxide, potassium hydroxide). In some embodiments, the solvent is an amine. In some embodiments, the amine is RₓNH₃₋ₓ, wherein R is selected from an optionally substituted alkyl, ether, or alcohol.

In some embodiments, the pH adjusting step is performed via water electrolysis. In some embodiments, the CO₂ source is an effluent from an industrial source (e.g., flue gas emitted from a natural gas-fired power plant, a coal-fired power plant, an iron mill, a steel mill, a cement plant, an ethanol plant, or a chemical manufacturing plant). In some embodiments, the CO₂ source is an atmospheric source (e.g., ambient air). In some embodiments, the pH adjusting step is performed at a temperature of less than 100° C. In some embodiments, the regenerated amine is collected and used for the same process again.

In some embodiments, the amine comprises: one or more primary amines (e.g., monoethanolamine (MEA), 2-ethylaminoethanol, 2-methylaminoethanol, ethylenediamine, benzylamine); one or more secondary amines (e.g., diethanolamine (DEA), pyrrolidine, morpholine, 2,6-Dimethylmorpholine, monoisopropanolamine, piperazine (PZ)); one or more tertiary amines (e.g., 2-(dimethylamino) ethanol (DMAE), N-tert-butyldiethanolamine (tBDEA), 3-dimethylamino-1-propanol (DMA-1P), 3-(dimethylamino)-1,2-propanediol (DMA-1,2-PD), 2-diethylaminoethanol (DEAE), 3-diethylamino-1,2-propanediol (DEA-1,2-PD), 3-diethylamino-1-propanol (DEA-1P), triethanolamine (TEA), 1-dimethylamino-2-propanol (DMA-2P), 1-(2-hydroxyethyl) pyrrolidine [1-(2HE) PRLD], 1-diethylamino-2-propanol (DEA-2P), 3-pyrrolidino-1,2-propanediol (PRLD-1,2-PD), 2-(diisopropylamino) ethanol (DIPAE), 1-(2-hydroxyethyl) piperidine [1-(2HE) PP], 2-(dimethylamino)-2-methyl-1-propanol (DMA-2M-1P), 3-piperidino-1,2-propanediol (3PP-1,2-PD), 3-dimethylamino-2,2-dimethyl-1-propanol (DMA-2,2-DM-1P), 3-hydroxy-1-methylpiperidine (3H-1MPP), N-ethyldiehanolamine, 1-ethyl-3-hydroxypiperidine); and mixtures thereof.

In some embodiments, the solution absorbing CO₂ has a basic pH (e.g., >7). In some embodiments, the pH of the solution absorbing CO₂ is greater than about 7, greater than about 7.5, greater than about 8, greater than about 8.5, greater than about 9, greater than about 9.5, greater than about 10, greater than about 10.5, greater than about 11, greater than about 11.5, or greater than about 12, or any range or value therein between. In some embodiments, the solution absorbing CO₂ has a pH of about 7, about 7.5, about 8, about 8.5, about 9, about 9.5, about 10, about 10.5, about 11, about 11.5, about 12, about 12.5, about 13, about 13.5, or about 14, or any range or value therein between.

In some embodiments, the CO₂ absorption step is performed at a temperature of less than about 100° C., less than about 95° C., less than about 90° C., less than about 85° C., less than about 80° C., less than about 75° C., less than about 70° C., less than about 65° C., less than about 60° C., less than about 55° C., less than about 50° C., less than about 45° C., less than about 40° C., less than about 30° C., or less than about 25° C., or any range or value therein between. In some embodiments, the CO₂ absorption step is performed at a temperature of about 100° C., about 95° C., about 90° C., about 85° C., about 80° C., about 75° C., about 70° C., about 65° C., about 60° C., about 55° C., about 50° C., about 45° C., about 40° C., about 30° C., or about 25° C., or any range or value therein between. In some embodiments, the CO₂ absorption step is performed under ambient conditions (e.g., room temperature and pressure).

In some embodiments, the pH of the solution is adjusted electrochemically to release the CO₂ as a concentrated vapor. In some embodiments, the pH of the solution is adjusted to less than about 7.5, less than about 7, less than about 6.5, less than about 6, less than about 5.5, less than about 5, less than about 4.5, less than about 4, less than about 3.5, less than about 3, less than about 2.5, less than about 2, less than about 1.5, or less than about 1, or any range or value therein between. In some embodiments, the pH of the solution is adjusted about 7.5, about 7, about 6.5, about 6, about 5.5, about 5, about 4.5, about 4, about 3.5, about 3, about 2.5, about 2, about 1.5, or about 1, or any range or value therein between.

In some embodiments, the pH adjusting step is performed at a temperature of less than about 100° C., less than about 95° C., less than about 90° C., less than about 85° C., less than about 80° C., less than about 75° C., less than about 70° C., less than about 65° C., less than about 60° C., less than about 55° C., less than about 50° C., less than about 45° C., less than about 40° C., less than about 30° C., or less than about 25° C., or any range or value therein between. In some embodiments, the pH adjusting step is performed at a temperature of about 100° C., about 95° C., about 90° C., about 85° C., about 80° C., about 75° C., about 70° C., about 65° C., about 60° C., about 55° C., about 50° C., about 45° C., about 40° C., about 30° C., or about 25° C., or any range or value therein between. In some embodiments, the pH adjusting step is performed under ambient conditions (e.g., room temperature and pressure).

In some embodiments, the concentrated vapor comprises (v/v) about 2% to about 99% CO₂, about 2% to about 95% CO₂, about 2% to about 90% CO₂, about 2% to about 85% CO₂, about 2% to about 80% CO₂, about 2% to about 75% CO₂, about 2% to about 70% CO₂, about 2% to about 65% CO₂, about 2% to about 60% CO₂, about 2% to about 55% CO₂, about 2% to about 50% CO₂, about 2% to about 45% CO₂, about 2% to about 40% CO₂, about 2% to about 35% CO₂, about 2% to about 30% CO₂, about 2% to about 25% CO₂, about 2% to about 20% CO₂, about 2% to about 15% CO₂, about 2% to about 10% CO₂, about 2% to about 5% CO₂, or any range or value therein. In some embodiments, the concentrated vapor comprises (v/v) about 2% CO₂, about 5% CO₂, % CO₂, about 10% CO₂, about 15% CO₂, about 20% CO₂, about 25% CO₂, about 30% CO₂, about 35% CO₂, about 40% CO₂, about 45% CO₂, about 50% CO₂, about 55% CO₂, about 60% CO₂, about 65% CO₂, about 70% CO₂, about 75% CO₂, about 80% CO₂, about 85% CO₂, about 90% CO₂, about 95% CO₂, about 96% CO₂, about 97% CO₂, about 98% CO₂, about 99% CO₂, or greater, or any range or value therein between.

A proof-of-concept of an electrochemical pH-swing system is disclosed in PCT International Application No. PCT/US22/25028, filed Apr. 15, 2022, which is hereby incorporated by reference in its entirety.

### Sequestration of Captured CO₂ by Mineralization

In some embodiments, methods according to the present disclosure include a method or step of sequestering CO₂ from the concentrated vapor produced in the CO₂ absorption step discussed above. In some embodiments, the method or step of sequestering CO₂ from the concentrated vapor produced in the CO₂ absorption step comprises: contacting the concentrated vapor containing CO₂ with an aqueous sequestration solution comprising ions capable of forming an insoluble carbonate salt, to produce an aqueous solution comprising carbon dioxide; contacting the aqueous solution comprising carbon dioxide with an electroactive mesh that induces its alkalinization thereby forcing the precipitation of a carbonate solid(s) from the sequestration solution; and removing the precipitated carbonate solids from the sequestration solution, or from the surface of the mesh where they may deposit.

In some embodiments, the aqueous sequestration solution is in thermal equilibrium with the gaseous stream. In some embodiments, the aqueous sequestration solution is not in thermal equilibrium with the gaseous stream.

In some embodiments, the ions capable of forming an insoluble carbonate salt comprise ions of one or more of the following: Ca, Mg, Ba, Sr, Fe, Zn, Pb, Cd, Mn, Ni, Co, Cu, and Al. In some embodiments, the aqueous solution comprises seawater or brine. In some embodiments, the aqueous solution has a concentration of NaCl of about 1,000 ppm or more, about 2,000 ppm or more, about 3,000 ppm or more, about 4,000 ppm or more, about 5,000 ppm or more, about 6,000 ppm or more, about 7,000 ppm or more, about 8,000 ppm or more, about 9,000 ppm or more, about 10,000 ppm or more, about 15,000 ppm or more, about 20,000 ppm or more, about 25,000 ppm or more, or about 30,000 ppm or more, about 35,000 ppm or more, about 40,000 ppm or more, about 45,000 ppm or more, about 50,000 ppm or more, about 55,000 ppm or more, or about 60,000 ppm or more, or greater, or any range or value therein between.

In some embodiments, the electroactive mesh comprises a mesh cathode that comprises a metallic or a non-metallic composition. In some embodiments, the electroactive mesh comprises, consists essentially of, or consists of a metallic or carbon-based mesh. In some embodiments, the electroactive mesh contains steel, stainless steel, titanium oxide, nickel and nickel alloys, carbon nanotubes, polymers, and/or graphite, or other hybrid compositions of these materials. In some embodiments, the electroactive mesh comprises pores having a diameter in the range of about 0.1 μm to about 10000 μm (e.g., about 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 1000, 1500, 2000, 3000, 4000, 5000, 6000, 7000, 8000, 9000, or 10000 μm).

In some embodiments, the method utilizes an end-to-end energy intensity of about 2.5 MWh or less per ton of carbon dioxide mineralized. In some embodiments, the aqueous solution contains an amount of dissolved carbon dioxide that is buffered to atmospheric abundance.

In some embodiments, the electroactive mesh produces an increased alkaline condition, in situ, in the aqueous sequestration solution within about 2 to 20000 μm of the electroactive mesh. In some embodiments, the alkalinized condition is a pH of 7 or greater, 7.5 or greater, 8 or greater, 8.5 or greater, 9 or greater, 9.5 or greater, 10 or greater, 10.5 or greater, 11 or greater, 11.5 or greater, or 12 or greater, or any range or value therein between. In some embodiments, the alkalinized condition is a pH of about 7, about 7.5, about 8, about 8.5, about 9, about 9.5, about 10, about 10.5, about 11, about 11.5, about 12, about 12.5, about 13, about 13.5, or about 14, or any range or value therein between.

In some embodiments, inducing the precipitation of the carbonate solid includes rotating a cylinder consisting of the electroactive mesh in the solution, while applying suction to draw the solution onto the outer surface of the mesh. In some embodiments, the method uses rotating disc cathodes.

In some embodiments, the solution is a brine solution. In some embodiments, the solution is an alkaline metal-containing solution. In some embodiments, inducing precipitation of the carbonate solid includes inducing precipitation of at least one carbonate comprising Ca, Mg, Ba, Sr, Fe, Zn, Pb, Cd, Mn, Ni, Co, Cu, or Al. In some embodiments, inducing precipitation of the carbonate solid includes inducing precipitation of at least one carbonate comprising Ca and/or Mg.

Some embodiments of the disclosure include flow-through electrolytic reactors comprising an intake device in fluid connection with a rotating cylinder comprising an electroactive mesh, and a scraping device and/or liquid-spray based device for separating a solid from a surface or solution.

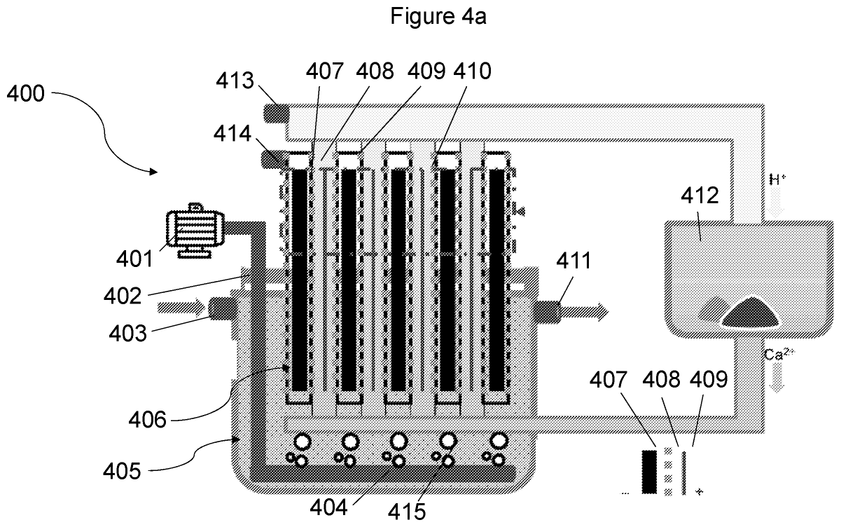

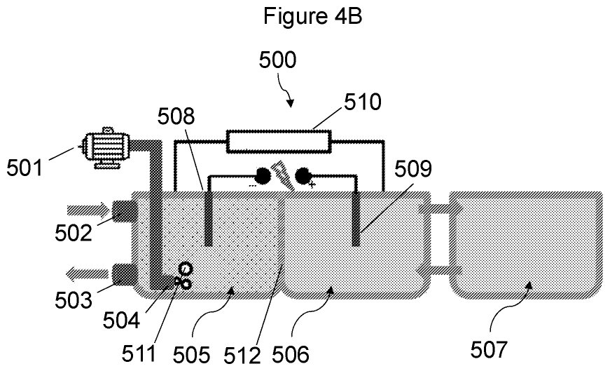

Referring now to FIG. 4A, a membrane-less reactor 400 was conceptualized to accommodate a single-step carbon sequestration and storage (sCS²) strategy, which is based on the electrochemically facilitated (Mg,Ca)-carbonate and/or hydroxide precipitation in seawater with the potential to capture gigatonnes of CO₂. By way of non-limiting example, such processes are disclosed in PCT Publication No. WO 2021/061213, filed Jun. 12, 2020, the entireties of which are hereby incorporated by reference herein.

A basic CO₂ mineralization process can be achieved by alkalizing a circumneutral Ca- and Mg-containing solution (e.g., seawater, alkaline metal-rich groundwater, industrial wastewater, desalination brine). We evaluated the feasibility of the conceptualized multi-compartments reactor, by using a single-compartment continuous stirred-tank reactor (CSTR). Operational parameters (e.g., voltage, current density, and hydraulic retention time (“HRT”)) may also be selected to demonstrate the carbonation energy intensity of the design.

Referring still to FIG. 4A, reactor 400 includes an air pump 401 in fluid communication with one or more air inlets 404 for introducing the atmospheric air and/or a concentrated CO₂ vapor into an aqueous sequestration solution (e.g. seawater) contained within reservoir 405. The reactor further includes a seawater inlet 403 and seawater outlet 411. Electrode assembly 406 is in fluid contact with the aqueous sequestration solution reservoir 405 and comprises rotating disk cathodes 407 and anodes 409 separated by a barrier layer 408. The rotating disc cathodes 407 (e.g. 316L stainless steel mesh) may be rotated around shaft 402 to pass a scraper 410 for product removal and collection. The reactor may further comprise a neutralization pool 412. O₂ may be produced at the anode 409, and may be released at an O₂ outlet 413. H₂ may be produced at the rotating disk cathode 407, and may be released at an H₂ outlet 414.

The electrolytes may be separated with a porous barrier for the following reasons: (1) minimized neutralization reactions between anolytes and catholytes allows stable cathode pH for CO₂ capture and mineralization; (2) separated electrolytes promote higher energy efficiency of the reactor; (3) the gas streams (H₂ and O₂) may need to be divided and collected separately; and (4) atmospheric CO₂ mineralization is, in general, an acidification process, and the surplus of produced acids need to be withheld to avoid ocean acidification.

Referring still to FIG. 4A, the catholyte may be air-purged and seawater-flushed such that the atmospheric CO₂ reacts with the electrolytic alkalinity to produce mineral carbonates and hydroxides. An online pH-monitoring system may be used, for example, to control the applied electric current to attain a constant catholyte pH at, e.g., 9.5-9.6. This pH advantageously maximizes atmospheric CO₂ capture or capture from a concentrated vapor containing CO₂ (e.g., produced in an absorption step discussed above). The stainless steel cathodes 407 may be covered by a hydrophobic mesh (e.g., polypropylene (PP) meshes) as carbonation catalysts.

The PP-covered stainless steel cathodes may be rotated to pass a scraper (e.g., a metallic brush, blade, or high-pressure nozzles) to remove the carbonates, thereby regenerating the cathode for subsequent carbonation as the disks rotate back into the liquid. A porous barrier 408 (e.g., cellulose or other polymer films) may be used to separate the anolyte (e.g., acid) from the catholyte (e.g., alkalinized seawater), preventing seawater acidification and CO₂ degassing. The anolyte may then be cycled to a neutralization pool 412 and the produced acidity will be consumed to dissolve mafic, ultramafic minerals, and rocks to restore the alkalinity. Ca-rich fly ashes and minerals (e.g., gypsum) may also be used to enrich the Ca²⁺ in the anolyte.

### EXAMPLES

### Example 1: Proof-of-Concept Two-Chamber Reactor

Referring now to FIG. 4B, to demonstrate a process according to the present disclosure, a two-chamber CSTR reactor 500 was employed with barrier layer (in this example filter paper) 512 to separate anolyte reservoir 505 and catholyte reservoir 506. A 0.3 M Na₂SO₄ solution was used as the anolyte, and a solution simulating the seawater composition (prepared using the INSTANT OCEAN® salt) was used as catholyte and introduced via inlet 502, and removed via out 503. A 316 stainless steel mesh covered with PP meshes was used as the cathode 508, while platinum-coated titanium plates were used as anode 509. In the CSTR set up, the flow rate of catholyte was controlled by a programmable syringe pump (New Era Pump Systems, Inc.), while a peristaltic pump was used to control the flow rate of anolyte. The catholyte pH was maintained at 9.5. Effective mixing and CO₂ equilibration was enabled by aeration with air pump 501, which introduces air via inlet 504. pH controller 510 maintains the desired pH in the anode chamber 506 and the aqueous sequestration solution reservoir 505. Anolyte pool 507 is in fluid communication with the anode chamber 506.

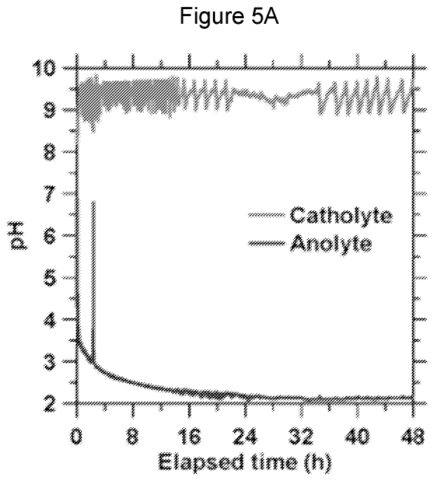

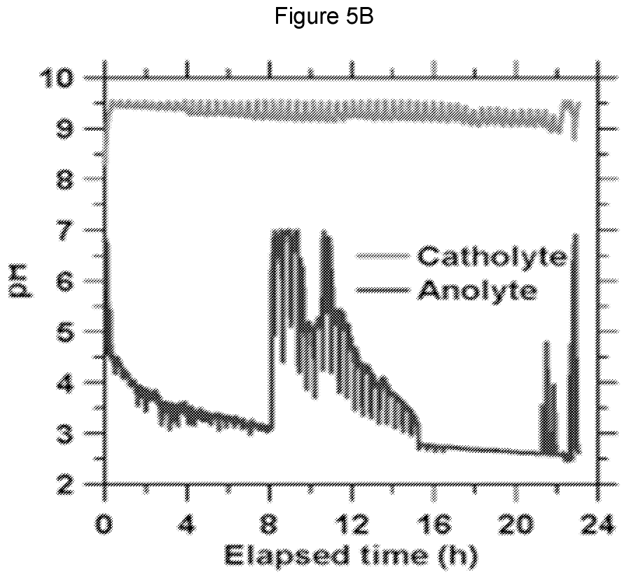

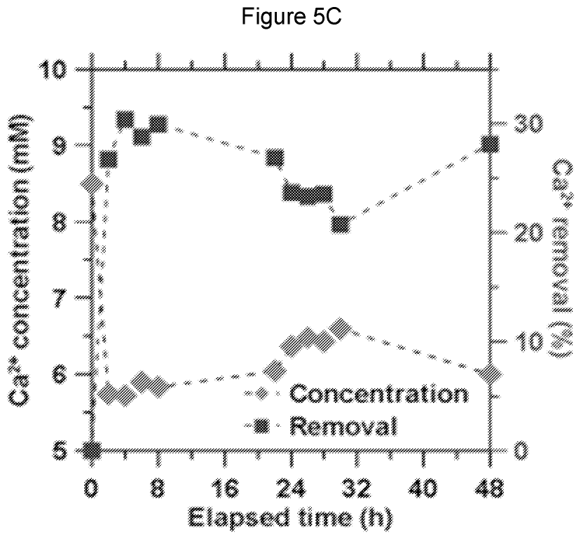

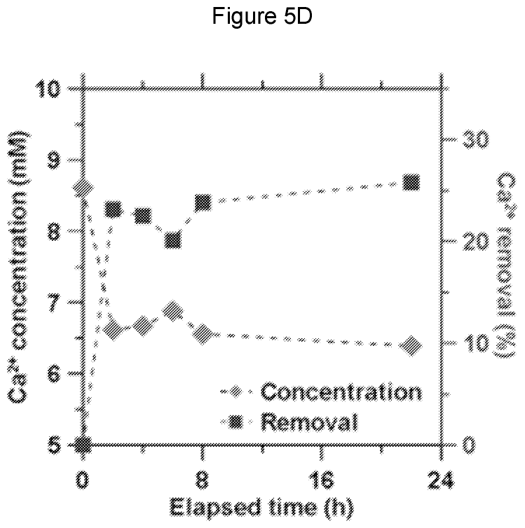

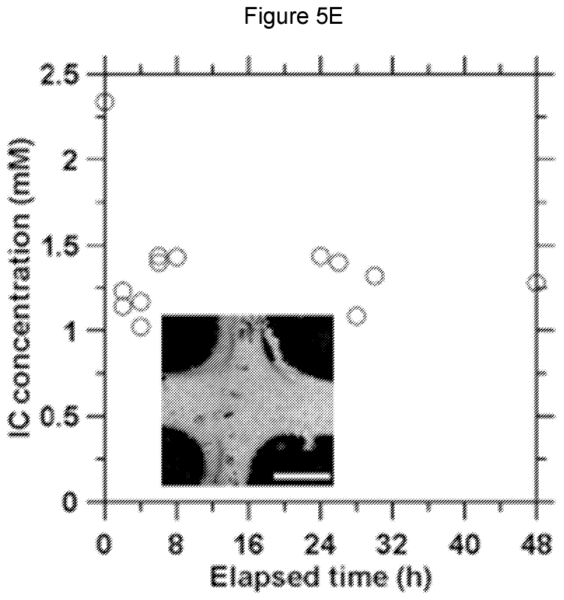

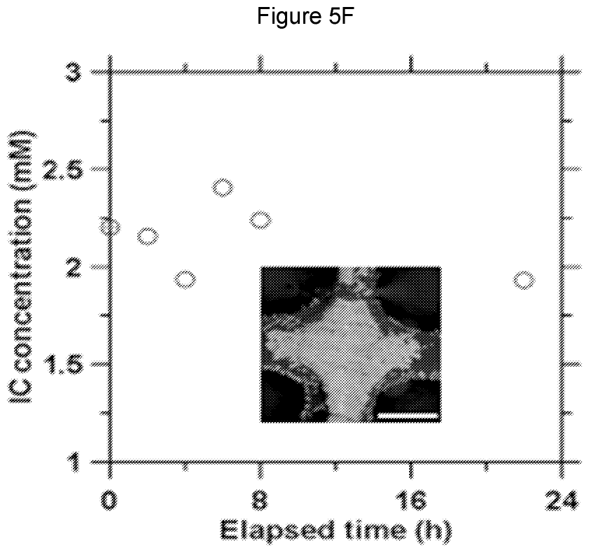

Referring now to FIGS. 5A-5F, two set of experiments (150 min-HRT and 10 min-HRT) were conducted with varying operating parameters. The barrier (filter paper) effectively separated the acidified and alkalinized electrolytes, demonstrating the feasibility of the membrane-less setup. Approximately 30% Ca removal was attained in the 150 min-HRT experiment (FIG. 5C), whereas the 10 min-HRT experiment achieves similar, but lower, Ca removal rates (˜25%, FIG. 5D), though the reactor accommodated much faster flow rate.

The seawater effluents of both experiments were controlled at a pH of 9.5, but the IC concentration is higher (2 mM) when HRT is 10 min. (FIG. 5F) as compared to that observed for the 150 min-HRT experiment (1.5 mM, FIG. 5E). As calculated from Ca removal and the effluent IC, the 10 min-HRT experiment is much more efficient regarding atmospheric CO₂ mineralization (˜0.09 g atmospheric CO₂/L seawater), as compared to the 150 min-HRT experiment (˜0.07 g atmospheric CO₂/L seawater). Further, the high pH and abundance of IC in the effluents from both experiments render further CO₂ capture capability when expelled into the sea. As shown in the insets for FIGS. 5E and 5F, the CO₂ was mineralized as aragonite (CaCO₃) that formed thick yet brittle scales on the PP meshes, permitting easy removal via a simple scraping process.

The electric energy intensity (EEI) of carbonation processes were calculated using the following Equation (7):

$$E E I = \frac{UI}{FR} \qquad ( 7 )$$

where U and I are the applied voltage and current (in MV, kV, V, or mV, and A, respectively), F is the flow rate (in L/h), and R is the atmospheric CO₂ removal rate (in ton of CO₂/L seawater). As a result, the energy efficiency of the 10 min-HRT experiment is outstanding (2.1-4.0 MWh/t CO₂) for atmospheric CO₂, as compared to the 150 min-HRT experiment (10.7 MWh/t CO₂) and the seawater alkalinization using NaOH as an additive (4.5 MWh/t CO₂).

### Example 2 (Prophetic)

While the reactor configuration described in EXAMPLE 1 is useful for CaCO₃ formation with air purging, MgCO₃ formation does not occur because of the kinetic limitations described above. The lack of MgCO₃ formation reduces the CO₂ removal capacity of the system by more than a factor of 5. To address this limitation, the mineralization process described above will be coupled with a low-energy, amine-based DAC process (e.g., similar to that disclosed in PCT application No. PCT/US22/25028, filed Apr. 16, 2021, the entirety of which is hereby incorporated by reference herein). This process (shown schematically in FIG. 1B) uses amine solutions (at pH>10) to absorb CO₂ from gas phase streams. However, the CO₂-rich amine is regenerated in an electrochemical cell in which protons are generated from aqueous solutions at the anode (and hydroxide ions at the cathode). These protons diffuse into the rich amine solution resulting in a decrease in the pH of the amine solution (pH<7) and the decomposition of carbamate ions and release of CO₂. (A salt bridge supplies anions to maintain charge neutrality in the amine solution and cations to the cathode solution.) The CO₂ is released as a gaseous stream containing 1-99% CO₂, which can be absorbed into seawater to increase the concentration of dissolved inorganic carbon to >>10 mM levels, which are sufficient for both CaCO₃ and MgCO₃ mineralization.

After CO₂ is released, the amine solution is restored to high pH via ion exchange using a strong base anion exchange resin. The basic solution from the cathode is used to regenerate the ion exchange resin, thereby recovering the salts for recycle into the salt bridge solution. This pH-swing process occurs at ambient temperature, and therefore offers at least the following advantages: (1) simpler process equipment requirements; (2) complete amine regeneration (and thus, maximum working capacity); and (3) reduced solvent loss. Importantly, this process requires ˜2× lower energy (2.8 MWh per tonne CO₂ captured) compared to thermal swing processes (>5.0 MWh per tonne CO₂ captured).

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

### REFERENCES

1. Keith, D. W.; Holmes, G.; St. Angelo, D.; Heidel, K. A Process for Capturing CO₂ from the Atmosphere. Joule 2018, 2 (8), 1573-1594.
2. Keith, D. W.; Ha-Duong, M.; Stolaroff, J. K. Climate Strategy with CO₂ Capture from the Air. Clim. Change 2006, 74 (1), 17-45.
3. Sakwattanapong, R.; Aroonwilas, A.; Veawab, A., Behavior of Reboiler Heat Duty for CO₂ Capture Plants Using Regenerable Single and Blended Alkanolamines. Ind. Eng. Chem. Res. 2005, 44, 4465-4473.
4. Feng, B.; Du, M.; Dennis, T. J.; Anthony, K.; Perumal, M. J., Reduction of Energy Requirement of CO₂ Desorption by Adding Acid into CO₂-Loaded Solvent. Energy & Fuels 2010, 24 (1), 213-219.
5. Dutcher, B.; Fan, M.; Russell, A. G., Amine-Based CO₂ Capture Technology Development from the Beginning of 2013—A Review. ACS Appl. Mater. Interfaces 2015, (7), 2137-2148.
6. MacDowell, N.; Florin, N.; Buchard, A.; Hallett, J.; Galindo, A.; Jackson, G.; Adjiman, C. S.; Williams, C. K.; Shah, N.; Fennell, P., An Overview of CO₂ Capture Technologies. Energy Environ. Sci. 2010, 3, 1645-1669.
7. Husebye, J.; Brunsvold, A. L.; Roussanaly, S.; Zhang, X., Techno Economic Evaluation of Amine based CO₂ Capture: Impact of CO₂ Concentration and Steam Supply. Energy Procedia 2012, 23, 381-390.
8. Roussanalya, S.; Fua, C.; Voldsunda, M.; Anantharamana, R.; Spinellib, M.; Romanob, M., Techno-economic analysis of MEA CO₂ capture from a cement kiln-impact of steam supply scenario. Energy Procedia 2017, 114, 6229-6239.
9. Liu, Y.; Ye, H.-Z.; Diederichsen, K. M.; Van Voorhis, T.; Hatton, T. A., Electrochemically mediated carbon dioxide separation with quinone chemistry in salt-concentrated aqueous media. Nat Commun 2020, 11 (1), 2278-2278.
10. Rahimi, M.; Catalini, G.; Puccini, M.; Hatton, T. A., Bench-scale demonstration of CO₂ capture with an electrochemically driven proton concentration process. RSC Advances 2020, 10 (29), 16832-16843.
11. Stern, M. C.; Hatton, T. A., Bench-scale demonstration of CO₂ capture with electrochemically-mediated amine regeneration. RSC Advances 2014, 4 (12), 5906.
12. Stern, M. C.; Simeon, F.; Herzog, H.; Hatton, T. A., Post-combustion carbon dioxide capture using electrochemically mediated amine regeneration. Energy & Environmental Science 2013, 6 (8), 2505.
13. Voskian, S.; Hatton, T. A., Faradaic electro-swing reactive adsorption for CO₂ capture. Energy & Environmental Science 2019, 12 (12), 3530-3547.
14. Wang, M.; Hariharan, S.; Shaw, R. A.; Hatton, T. A., Energetics of electrochemically mediated amine regeneration process for flue gas CO₂ capture. International Journal of Greenhouse Gas Control 2019, 82, 48-58.
15. Wang, M.; Herzog, H. J.; Hatton, T. A., CO₂ Capture Using Electrochemically Mediated Amine Regeneration. Industrial & Engineering Chemistry Research 2020, 59 (15), 7087-7096.
16. Wang, M.; Rahimi, M.; Kumar, A.; Hariharan, S.; Choi, W.; Hatton, T. A., Flue gas CO₂ capture via electrochemically mediated amine regeneration: System design and performance. Applied Energy 2019, 255, 113879.
17. Adenier, A.; Chehimi, M. M.; Gallardo, I.; Pinson, J.; Vilà, N., Electrochemical Oxidation of Aliphatic Amines and Their Attachment to Carbon and Metal Surfaces. Langmuir 2004, 20, 8243-8253.
18. Ivy, J. Summary of Electrolytic Hydrogen Production; Milestone Completion Report NREL/MP-560-36734; 2004.
19. Rau, G. H.; Carroll, S. A.; Bourcier, W. L.; Singleton, M. J.; Smith, M. M.; Aines, R. D., Direct electrolytic dissolution of silicate minerals for air CO₂ mitigation and carbon-negative H₂ production. Proc Natl Acad Sci USA 2013, 110 (25), 10095-10100.
20. Arshad, M. W.; Fosbøl, P. L.; von Solms, N.; Svendsen, H. F.; Thomsen, K., Equilibrium Solubility of CO₂ in Alkanolamines. Energy Procedia 2014, 51, 217-233.
21. Arshada, M. W.; Fosbøla, P. L.; Nicolas von Solmsa, H.; Svendsenb, F.; Thomsena, K., Equilibrium Solubility of CO₂ in Alkanolamines. Energy Procedia 2014, 51, 217-223.

What is claimed is:

1. A method of capturing CO₂ from a gas source, comprising:
(a) concentrating CO₂ from the gas source in a concentration step comprising:
(i) contacting the gas source with an absorption solution having a solvent and a solute, wherein the solvent and/or the solute comprises an amine, thereby forming a solution comprising the amine-CO₂ complex;
(ii) electrochemically adjusting the pH of the absorption solution electrochemically to less than about 7 to, thereby releasing the CO₂ as a concentrated vapor;
(iii) collecting the concentrated vapor; and
(b) sequestering CO₂ from the concentrated vapor in a sequestration step comprising:
(iv) contacting the concentrated vapor with an aqueous sequestration solution comprising ions capable of forming an insoluble carbonate salt, such that the aqueous sequestration solution comprises the CO₂;
(v) contacting the aqueous sequestration solution comprising the CO₂ with an electroactive surface to basify the aqueous sequestration solution comprising the CO₂, thereby precipitating a carbonate solid; and
(vi) separating the carbonate solids from the aqueous sequestration solution or the electroactive surface.

2. The method of claim 1, wherein the anionic complex comprises carbamate ions.

3. The method of claim 1 or 2, wherein the solvent comprises an amine.

4. The method of claim 1 or 2 wherein the solute comprises an amine.

5. The method of claim 1 or 2, wherein the solvent and the solute comprise an amine.

6. The method of any one of claims 3 to 5, wherein the amine is a primary amine, a secondary amine, a tertiary amine, or a mixture thereof.

7. The method of claim 6, wherein the amine is a primary amine or a secondary amine.

8. The method of claim 6 or 7, wherein the amine has a structure of formula I:
RₓNH₃₋ₓ, (I);
wherein R is selected from an optionally substituted alkyl, ether, and hydroxyalkyl, or two R, together with the nitrogen atom to which they are joined, forms a nitrogen containing heterocycle; and
x is 1, 2 or 3.

9. The method of claim 8, wherein wherein the amine is chosen from monoethanolamine, 2-ethylaminoethanol, 2-methylaminoethanol, ethylenediamine, benzylamine, diethanolamine, pyrrolidine, morpholine, 2,6-dimethylmorpholine, monoisopropanolamine, piperazine 2-(dimethylamino)ethanol, N-tert-butyldiethanolamine, 3-dimethylamino-1-propanol, 3-(dimethylamino)-1,2-propanediol, 2-diethylaminoethanol, 3-diethylamino-1,2-propanediol, 3-diethylamino-1-propanol, triethanolamine, 1-dimethylamino-2-propanol, 1-(2-hydroxyethyl)pyrrolidine, 1-diethylamino-2-propanol, 3-pyrrolidino-1,2-propanediol, 2-(diisopropylamino)ethanol, 1-(2-hydroxyethyl)piperidine, 2-(dimethylamino)-2-methyl-1-propanol, 3-piperidino-1,2-propanediol, 3-dimethylamino-2,2-dimethyl-1-propanol, 3-hydroxy-1-methylpiperidine, N-ethyldiethanolamine, 1-ethyl-3-hydroxypiperidine, and any combination thereof.

10. The method of any one of claims 1-9, wherein the solvent comprises water.

11. The method of any one of claims 1-10, wherein step (ii) comprises water electrolysis.

12. The method of any one of claims 1-11, wherein the gas source comprise about 0.4 to about 25% (v/v) CO₂.

13. The method of any one of claims 1-12, wherein the gas source is an effluent from an industrial source.

14. The method of any one of claims 1-13, wherein step (ii) is performed at a temperature of less than about 100° C.

15. The method of any one of claims 1-14, wherein the gas source is an atmospheric source.

16. The method of any one of claims 1-15, wherein the concentrated vapor comprises about 2-99% (v/v) CO₂.

17. The method of any one of claims 1-16, wherein the concentrated vapor comprises 2-15% (v/v) CO₂.

18. The method of any one of claims 1-17, wherein the absorption solution is regenerated using a strong base anion exchange resin.

19. The method of any one of claims 1 to 18, wherein the aqueous sequestration solution is in thermal equilibrium with the gaseous stream.

20. The method of any one of claims 1 to 18, wherein the aqueous sequestration solution is not in thermal equilibrium with the gaseous stream.

21. The method of any one of claims 1-20, wherein the ions capable of forming an insoluble carbonate salt are chosen from ions of Ca, Mg, Ba, Sr, Fe, Zn, Pb, Cd, Mn, Ni, Co, Cu, Al, and any combination thereof.

22. The method of any one of claims 1-21, wherein the aqueous sequestration solution comprises NaCl at a concentration of about 1,000 ppm or more.

23. The method of any one of claims 1-22, wherein the aqueous sequestration solution comprises NaCl at a concentration of about 30,000 ppm or more.

24. The method of any one of claims 1-23, wherein the aqueous sequestration solution comprises seawater.

25. The method of any one of claims 1-24, wherein the electroactive surface comprises a an anode and/or a cathode comprising a metallic or a non-metallic composition.

26. The method of any one of claims 1-25, wherein the electroactive mesh increases basicity, in situ, of the aqueous sequestration solution within a distance of about 2 to 20,000 μm from the electroactive mesh.

27. The method of claim 26, wherein the pH of the aqueous sequestration solution is at least about 9.

28. The method of claim 27, wherein the pH of the aqueous sequestration solution is about 9 to about 10.

29. The method of any one of claims 1-28, wherein the electroactive surface is an electroactive mesh.

30. the method of claim 29, wherein the electroactive mesh is a metallic mesh, a carbon-based mesh, or a combination of both.

31. The method of claim 30, wherein the electroactive mesh comprises steel, stainless steel, titanium oxide, nickel and nickel alloys, carbon nanotubes, polymers, graphite, or any combination thereof.

32. The method of any one of claims 1 to 31, wherein the electroactive mesh comprises pores having a diameter in the range of about 0.1 μm to about 10,000 μm.

33. The method of any one of claims 1 to 32, wherein the aqueous sequestration solution is a brine solution.

34. The method of any one of claims 1 to 33, wherein the aqueous sequestration solution is an alkaline earth metal-containing solution.

35. The method of any one of claims 1 to 34, wherein precipitating the carbonate solid includes precipitating a carbonate comprising an ion of Ca, Mg, Ba, Sr, Fe, Zn, Pb, Cd, Mn, Ni, Co, Cu, Al, or any combination thereof.

36. The method of any one of claims 1 to 35, wherein separating the carbonate solid(s) from the solution or the surface of the electroactive mesh comprises rotating a rotating disc cathode having the electroactive mesh on its surface past a scraper, wherein the scraper removes the precipitated carbonate from the surface of the mesh.

37. The method of any one of claims 1 to 36, wherein step (a) further comprises (iv) regenerating the solvent and/or the solute.

38. The method of claim 37, wherein regenerating the solvent and/or the solute comprises adjusting the pH of the aqueous sequestration solution to greater than about 8.

39. The method of claim 38, wherein step (a) further comprises optionally collecting the regenerated solvent and/or solute after step (iii).

40. The method of claim 38, wherein the regenerated solvent is collected and reused in step (i) at least once.
